(19) United States
(12) Patent Application Publication
(10) Pub. No.: US 2003/0107344 A1
(43) Pub. Date: Jun. 12, 2003

(54) Motor drive circuit

(76) Inventor: Yutaka Saeki, Kanagawa (JP)

Correspondence Address: Darryl G. Walker, WALKER & SAKO, LLP, Suite 235, 300 South First Street, San Jose, CA, 95113, US

(21) Appl. No.: 10/309,721

(22) Filed: Dec. 4, 2002

(30) Foreign Application Priority Data
Dec. 6, 2001 (JP) 2001-372952

(51) Int. Cl. H02P 7/42

(52) U.S. Cl. 318/801

(57) ABSTRACT

A motor drive circuit (1) that may reduce an influence of electromotive forces on a control circuit (12) or the like has been disclosed. A motor drive circuit (1) may include an inverter circuit (11), a control circuit (12) and a back electromotive force suppressing circuit (13). A back electromotive force suppressing circuit (13) may include comparators (41, 43, and 45) for detecting a first back electromotive force having a voltage higher than a power supply voltage and comparators (42, 44, and 46) for detecting a second back electromotive force having a voltage lower than a reference potential (ground). Back electromotive force suppressing circuit (13) may provide drive control signals (81 to 86) to turn on a respective transistor (21 to 26) in an inverter circuit (11) in response to an output of a respective comparator (41 to 46). A respective transistor (81 to 86) may be turned on upon the detection of a back electromotive force. In this way, forward biasing of parasitic devices may be prevented and effects on a control circuit (12) or the like may be reduced.

### TECHNICAL FIELD

The present invention relates generally to a motor drive circuit and more particularly to a motor drive circuit including a voltage type inverter and the motor drive circuit may be used for a three-phase brushless motor.

### BACKGROUND OF THE INVENTION

Referring now to FIG. 4, a circuit schematic diagram of a conventional motor drive circuit is set forth and given the general reference character 101.

Conventional motor drive circuit 101 includes an inverter circuit 111 and a control circuit 112. Control circuit 112 provides control for inverter circuit 111. Inverter circuit 111 converts a DC voltage into an AC voltage according to a pulse width modulation (PWM) method and supplies the result into a three-phase motor circuit 102.

Inverter circuit 111 includes three output transistor pairs (121-122, 123-124, and 125-126) corresponding to individual phases of motor 102. Each output transistor pair includes a p-channel MOS (metal-oxide-semiconductor) transistor (121, 123, and 125) and a n-channel MOS transistor (122, 124, and 126). Each MOS transistor (121 to 126) functions as a switching device.

P-type MOS transistor 121 has a source connected to a power supply voltage VDD, a drain connected to an output terminal P101, and a gate connected to receive a control signal V_{C1} from control circuit. N-type MOS transistor 122 has a source connected to ground, a drain connected to output terminal P101, and a gate connected to receive a control signal V_{C2} from control circuit. P-type MOS transistor 123 has a source connected to a power supply voltage VDD, a drain connected to an output terminal P102, and a gate connected to receive a control signal V_{C3} from control circuit. N-type MOS transistor 124 has a source connected to ground, a drain connected to output terminal P102, and a gate connected to receive a control signal V_{C4} from control circuit. P-type MOS transistor 125 has a source connected to a power supply voltage VDD, a drain connected to an output terminal P103, and a gate connected to receive a control signal V_{C5} from control circuit. N-type MOS transistor 126 has a source connected to ground, a drain connected to output terminal P103, and a gate connected to receive a control signal V_{C6} from control circuit 112.

Inverter circuit 111 includes diodes (131 to 136). A respective diode (131 to 136) is connected in parallel to a respective MOS transistor (121 to 126). Diode 131 has an anode connected to output terminal P101 and a cathode connected to power supply voltage VDD. Diode 132 has an anode connected to ground and a cathode connected to output terminal P101. Diode 133 has an anode connected to output terminal P102 and a cathode connected to power supply voltage VDD. Diode 134 has an anode connected to ground and a cathode connected to output terminal P102. Diode 135 has an anode connected to output terminal P103 and a cathode connected to power supply voltage VDD. Diode 136 has an anode connected to ground and a cathode connected to output terminal P103.

Each diode (131 to 136) is formed parasitically in the formation of the backgate (body) connection of the respective MOS transistor (121 to 126). Such a diode is generally called a “body diode” (or a “built-in diode”).

By connecting a respective diode (131 to 136) in parallel to a respective MOS transistor (121 to 126), the drain to source voltage of each MOS transistor (121 to 126) is clamped. In this way, MOS transistors (121 to 126) are protected from back electromotive forces, as described below.

Motor 102 includes armature coils (L101 to L103). Each armature coil (L101 to L103) has a commonly connected terminal and another terminal connected to a respective output terminal (P101 to P103) of inverter circuit 111. Terminal P101 is connected to armature coil L101. Terminal P102 is connected to armature coil L102. Terminal P103 is connected to armature coil L103.

Control circuit 112 provides control signals (V_{C1} to V_{C6}) to a gate of a respective MOS transistor (121 to 126).

In conventional motor drive circuit 101 having the configuration described above, according to control signals (V_{C1}, V_{C3}, and V_{C5}) one of p-channel MOS transistors (121, 123, and 125) turns on (is in a conductive state), and the others of p-channel MOS transistors (121, 123, and 125) turn off (are in a non-conductive state). Similarly, according to control signals (V_{C2}, V_{C4}, and V_{C6}) one of n-channel MOS transistors (122, 124, and 126) turns on and the others of n-channel MOS transistors (122, 124, and 126) turn off. Control is performed so that a p-channel MOS transistor (121, 123, and 125) and a corresponding n-channel MOS transistor (122, 124, and 126) that from an output transistor pair (121-122, 123-124, and 125-126) are not simultaneously turned on.

The on/off states of MOS transistors (121 to 126) are thus controlled so that pulsed voltage (V₀₁, V₀₂, and V₀₃) having variable amplitudes are generated at output terminals (P101, P102, and P103), respectively, and provided to armature coils (L101, L102, and L103), respectively. In this way, motor 102 is rotationally driven.

In motor drive circuit 101, when a MOS transistor (121 to 126) turns from on to off, back electromotive forces are generated in the armature coils (L101, L102, and L103) of motor 102. For example, when MOS transistors (122 and 125) are turned on and MOS transistors (121, 123, 124, and 126) are turned off, a current flows from output terminal P103 through armature coils (L103 and L101) to output terminal P101. Thereafter, MOS transistor 122 turns off and MOS transistor 124 turns on. The instant MOS transistor 122 turns off, the current in armature coil L101 continues to flow due to inductive effects. As a result, a back electromotive force having a voltage value higher than the power supply VDD is generated at output terminal P101. Similarly, when MOS transistors (124 and 126) transition from on to off, back electromotive forces, each having a voltage value higher than power supply voltage VDD, are generated at the respective output terminals (P102 and P103).

On the other hand, when MOS transistors (121 and 126) are each turned on, and MOS transistors (122, 123, 124, and 125) are each turned off, a current flows from output terminal P101 through armature coils (L101 and L103) to output terminal P103. Thereafter, MOS transistor 121 turns off and MOS transistor 123 turns on. The instant MOS transistor 121 turns off, the current in armature coil L101 continues to flow due to inductive effects. As a result, a back electromotive force having a voltage value lower than the ground voltage is generated at output terminal P101. Similarly, when MOS transistors (123 and 125) transition from on to off, back electromotive forces, each having a voltage value lower than the ground voltage, are generated at the respective output terminals (P102 and P103).

FIG. 5 is a cross sectional view illustrating a conventional semiconductor device on which conventional motor drive circuit 101 is formed. For simplicity, FIG. 5 only shows a portion of a conventional semiconductor device where MOS transistors (121 and 122) of inverter circuit 111 are formed and a portion where two MOS transistors (184 and 185) for control circuit 112 are formed.

Referring now to FIG. 5, the conventional semiconductor device includes a p-type semiconductor substrate 181 containing n-type wells (182 and 183) therein.

P-channel MOS transistor 121 of inverter circuit 111 is formed on well 182 and diode 131 is formed inside well 182. N-channel MOS transistors 122 of inverter circuit 111 is formed outside of well 182 on semiconductor substrate 181. Diode 132 is formed inside semiconductor substrate 181 in the vicinity of n-channel MOS transistor 122.

P-channel MOS transistor 184 of control circuit 112 is formed on well 183. N-channel transistor 185 of control circuit 112 is formed outside well 183 on semiconductor substrate 181.

In the conventional semiconductor device, diode 132 turns on (forward biased) when a back electromotive force having a voltage value lower than the ground voltage, as described above, is generated at output terminal P101 and a voltage V₀₁ of output terminal P101 becomes lower or equal a threshold voltage of diode 132 below the ground voltage. As a result, a current flows from a ground line to output terminal P101 via diode 132 and the voltage V₀₁ of output terminal P101 rises toward the ground voltage. In this way, n-channel MOS transistor 122 is protected.

At this time, electrons travel from output terminal P101 not only in the direction indicated by an arrow 191 shown in FIG. 5, but also in the direction indicated by an arrow 192. Electrons traveling in the direction indicated by arrow 192 can be collected by, for example, n-well 183 of control circuit 112 or source/drain connections of n-channel transistor 185 of control circuit 112. For this reason, the voltage at each drain terminal (186 and 187) of respective MOS transistors (184 and 185) can vary and cause noise generation. In this way, other circuits of control circuit 112 formed on semiconductor substrate 181 can be adversely affected.

The above-described phenomenon can also occur in either of the other MOS transistors (124 and 126). In addition, a similar phenomenon can also occur when a back electromotive force having a voltage value higher than the power supply voltage VDD is generated in any of output terminals (P101 to P103).

Hitherto, techniques of suppressing back electromotive forces occurring at output terminals (P101 to P103) have been proposed. One such technique is disclosed in Japanese patent Application Laid-open No. Hei 2-55595 (JPA 2-55595).

A conventional motor drive circuit disclosed in JPA 2-55595 includes a conduction circuit for causing transistors on the side of a lower arm provided on the output stage to turn to a conduction state, and a voltage-detecting circuit for activating the conduction circuit when the voltage at a common node (i.e., an output terminal) between the transistors on an upper arm side and a lower arm side becomes lower than a predetermined voltage. In this way, voltages at the output terminals may be maintained constant.

As described above, conventional motor drive circuit 101 shown in FIG. 4 has a drawback in that noise can be generated in circuits other than inverter circuit 111 of control circuit 112, or the like, due to back electromotive forces occurring at output terminals (P101, P102, and P103).

In addition, a conventional motor drive circuit disclosed in JPA 2-55595 can have drawbacks as will now be described.

In the conventional motor drive circuit disclosed in JPA 2-55595, a diode connected to an output terminal is used to detect a back electromotive force. A conduction circuit is activated before the parasitic transistor turns on. Therefore, the diode for detecting a back electromotive force needs to have a threshold voltage set lower than that of the parasitic transistor. The threshold voltage of the diode, which is used as a reference for detecting a back electromotive force, is a fixed value. In other words, after the circuit is manufactured, the threshold voltage of the diode cannot be externally adjusted. Therefore, a drawback in conventional motor drive circuit disclosed in JPA 2-55595 is that the reference (reference voltage) used for detecting a back electromotive force cannot be adjusted in order to minimize back electromotive forces.

For example, when the response speeds of the voltage-detecting circuit and conduction circuit are insufficient, the parasitic transistor turns on (conducts current) before the transistor on the lower-arm side turns on. In such a case, the timing of turning the lower-arm side transistor on needs to be adjusted by resetting the reference voltage. However, in the conventional motor drive circuit disclosed in JPA 2-55595, because the timing cannot be adjusted in the above-mentioned manner, the influence of the back electromotive force can unexpectedly increase.

In view of the above discussion, it would be desirable to provide motor drive circuit that may be capable of suppressing the generation of noise attributed to back electromotive force.

It would also be desirable to provide a motor drive circuit in which influences of back electromotive forces may be adjusted so as to be reduced.

It would also be desirable to provide motor drive circuit in which a control circuit and other circuits may have a reduced influence from back electromotive forces.

### SUMMARY OF THE INVENTION

According to the present embodiments, a motor drive circuit that may reduce an influence of electromotive forces on a control circuit or the like is been disclosed. A motor drive circuit may include an inverter circuit, a control circuit, and a back electromotive force suppressing circuit. A back electromotive force suppressing circuit may include comparators for detecting a first back electromotive force having a voltage higher than a power supply voltage and comparators for detecting a second back electromotive force having a voltage lower than a reference potential (ground). Back electromotive force suppressing circuit may provide drive control signals to turn on a respective transistor in an inverter circuit in response to an output of a respective comparator. A respective transistor may be turned on upon the detection of a back electromotive force. In this way, forward biasing of parasitic devices may be prevented and effects on a control circuit or the like may be reduced.

According to one aspect of the embodiments, a motor drive circuit may include an inverter circuit, a control circuit, a plurality of first comparators and a plurality of second comparators. The inverter circuit may include a plurality of first transistors and a plurality of second transistors. Each first transistor may have a current path coupled between a first power supply line for supplying a first voltage and one of a plurality of output terminals. Each second transistor may have a current path coupled between a second power supply line for supplying a second voltage and one of a plurality of output terminals. A control circuit may provide a plurality of first control signals for controlling conduction/non-conduction of the plurality of first transistors and a plurality of second control signals for controlling conduction/non-conduction of the plurality of second transistors to provide power to armature coils of a motor via the plurality of output terminals. Each first comparator may compare a voltage at a corresponding one of the output terminals with the first voltage to detect the generation of a first back electromotive force. Each second comparator may compare a voltage at a corresponding one of the output terminals with the second voltage to detect the generation of a second back electromotive force. Upon detection of the first back electromotive force, one of the plurality of first comparators may provide a first comparator output that places the first transistor corresponding to the output terminal at which the first back electromotive force has been detected to a conduction state and upon detection of the second back electromotive force, one of the plurality of second comparators may provide a second comparator output that places the second transistor corresponding to the output terminal at which the second back electromotive force has been detected to a conduction state.

According to another aspect of the embodiments, the motor drive circuit may include a plurality of AND gates. Each AND gate may provide the logical product of one of the plurality of first control signals and one of the first comparator outputs to provide a first drive control signal to a control gate of one of the plurality of first transistors.

According to another aspect of the embodiments, the motor drive circuit may include a plurality of OR gates. Each OR gate may provide the logical sum of one of the plurality of second control signals and one of the second comparator outputs to provide a second drive control signal to a control gate of one of the plurality of second transistors.

According to another aspect of the embodiments, each of the plurality of first transistors and the plurality of second transistors may be an insulated gate field effect transistor (IGFET).

According to another aspect of the embodiments, each of the first plurality of transistors may be a p-type IGFET. Each of the second plurality of transistors may be a n-type IGFET.

According to another aspect of the embodiments, a motor drive circuit may include an inverter circuit, a control circuit, a first comparator and a second comparator. The inverter circuit may include a plurality of first transistors and a plurality of second transistors. Each first transistor may have a current path coupled between a first power supply line for supplying a first voltage and one of a plurality of output terminals. Each second transistor may have a current path coupled between a second power supply line for supplying a second voltage and one of a plurality of output terminals. A control circuit may provide a plurality of first control signals for controlling conduction/non-conduction of the plurality of first transistors and a plurality of second control signals for controlling conduction/non-conduction of the plurality of second transistors to provide power to armature coils of a motor via the plurality of output terminals. A first comparator may compare a voltage at one of the plurality of output terminals with the first voltage to detect the generation of a first back electromotive force. A second comparator may compare a voltage at a one of the plurality of output terminals with the second voltage to detect the generation of a second back electromotive force. Upon detection of the first back electromotive force, the first comparators may provide a first comparator output that places the first transistor corresponding to the output terminal at which the first back electromotive force has been detected to a conduction state and upon detection of the second back electromotive force, the second comparator may provide a second comparator output that places the second transistor corresponding to the output terminal at which the second back electromotive force has been detected to a conduction state.

According to another aspect of the embodiments, the motor drive circuit may include a first switch, a second switch, and a third switch. A first switch may provide the voltage of one of the plurality of output terminals to the first and second comparators. A second switch may provide the first comparator output to the first transistor corresponding to the one of the plurality of output terminals having the voltage provided by the first switch. A third switch may provide the second comparator output to the second transistor corresponding to the one of the plurality of output terminals having the voltage provided by the first switch.

According to another aspect of the embodiments, the motor drive circuit may include a plurality of AND gates. Each AND gate may provide the logical product of one of the plurality of first control signals and the first comparator output to provide a first drive control signal to a control gate of one of the plurality of first transistors.

According to another aspect of the embodiments, the motor drive circuit may include a plurality of OR gates. Each OR gate may provide the logical sum of one of the plurality of second control signals and the second comparator outputs to provide a second drive control signal to a control gate of one of the plurality of second transistors.

According to another aspect of the embodiments, a motor drive circuit may include a drive circuit and a detection circuit. A drive circuit may be connected to a plurality of output terminals. The drive circuit may include a first and second transistor for each output terminal. A first transistor may provide a first controllable impedance path between the output terminal and a first power terminal. A second transistor may provide a second controllable impedance path between the output terminal and a second power terminal. A detection circuit may receive a voltage from one of the plurality of output terminals and may provide a first detection signal. The first detection signal may turn on the first transistor corresponding to the one of the plurality of output terminals of which the voltage is received when the received voltage reaches a first predetermined voltage.

According to another aspect of the embodiments, the first power terminal may receive a first voltage level. The second power terminal may receive a second voltage level lower than the first voltage level. The first predetermined voltage may be a voltage higher than the first voltage level.

According to another aspect of the embodiments, each of the first transistors may be p-type IGFETs.

According to another aspect of the embodiments, the first power terminal may receive a first voltage level. The second power terminal may receive a second voltage level higher than the first voltage level. The first predetermined voltage may be a voltage lower than the first voltage level.

According to another aspect of the embodiments, each of the first transistors may be n-type IGFETs.

According to another aspect of the embodiments, a detector circuit may include a comparator. A comparator may have a non-inverting input connected to the first power terminal and an inverting input connected to the one of the plurality of output terminals and may provide the first detection signal at an output.

According to another aspect of the embodiments, the detection circuit may provide a second detection signal that turns on the second transistor corresponding to the one of the plurality of output terminals from which the voltage is receive when the received voltage reaches a second predetermined voltage.

According to another aspect of the embodiments, the detection circuit may receive a voltage from each of the plurality of output terminals and may provide a first detection signal for each first transistor. Each first transistor may turn on in response to the corresponding first detection signal when the corresponding output terminal reaches the first predetermined voltage.

According to another aspect of the embodiments, the drive circuit may provide power to armature coils of a motor via the plurality of output terminals.

### BRIEF DESCRIPTION OF THE DRAWINGS

FIG. 1 is a circuit schematic diagram of a motor drive circuit according to an embodiment.

FIG. 2(a) is a table illustrating the operating states (on/off) of transistors (21 to 26) and the direction of current flow in armature coils (L1 to L3) of three-phase brushless motor 2 in operation time periods (T1 to T6) according to an embodiment.

FIG. 2(b) is a timing diagram illustrating voltage variations of output terminals (P1 to P3) in time periods (T1 to T6) according to an embodiment.

FIG. 3 is a circuit schematic diagram of a motor drive circuit according to an embodiment.

FIG. 4 is a circuit schematic diagram of a conventional motor drive circuit.

FIG. 5 is a cross sectional view illustrating a conventional semiconductor device on which a conventional motor drive circuit is formed.

### DETAILED DESCRIPTION OF THE EMBODIMENTS

Various embodiments of the present invention will now be described in detail with reference to a number of drawings.

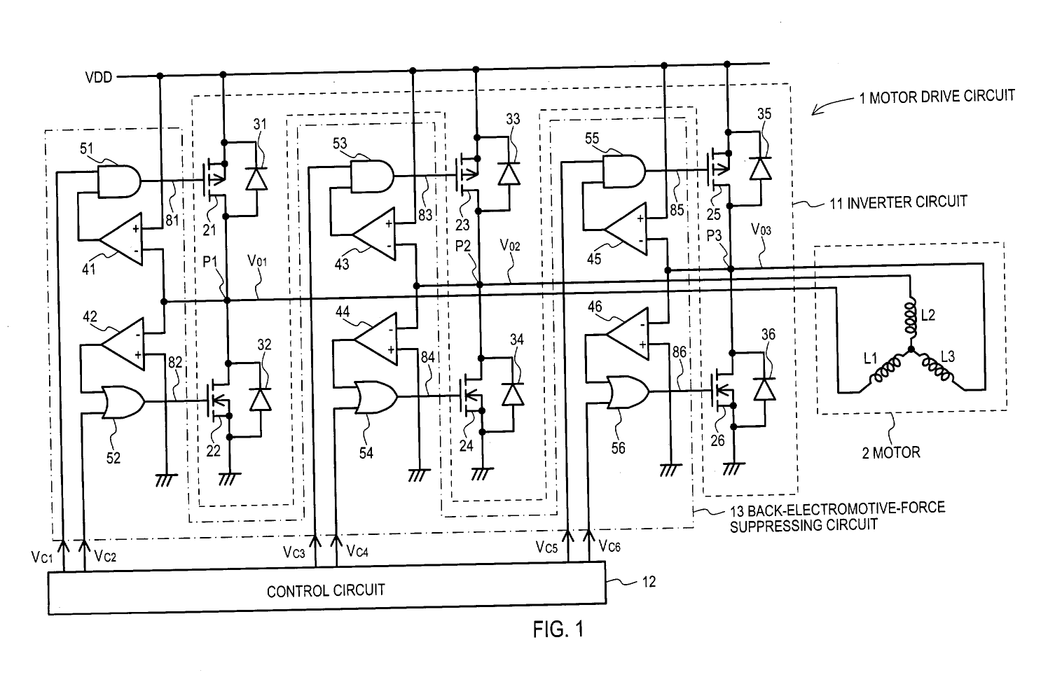

Referring now to FIG. 1, a circuit schematic diagram of a motor drive circuit according to an embodiment is set forth and given the general reference character 1.

Motor drive circuit 1 may include an inverter circuit 11, a control circuit 12, and a back electromotive force suppressing circuit 13. Control circuit 12 may provide control for inverter circuit 11. Inverter circuit 11 may convert a DC voltage into an AC voltage according to a pulse width modulation (PWM) method and may supply the result into a three-phase motor circuit 2. Back electromotive force suppressing circuit 13 may suppress back electromotive forces which may be generated at an output terminal of inverter circuit 11.

Control circuit 12 may provide control signals (V_{C1} to V_{C6}) to back electromotive force suppressing circuit 13. Back electromotive force suppressing circuit 13 may receive a power supply voltage VDD, a ground voltage, voltages (V₀₁ to V₀₃) of output terminals (P1 to P3), and control signals (V_{C1} to V_{C6}) and may provide outputs to control gates of transistors (21 to 26) in inverter circuit 11. Inverter circuit 11 may convert a DC voltage into an AC voltage according to a PWM method and may supply the result into a three-phase motor circuit 2 through output terminals (P1 to P3).

Inverter circuit 11 may includes three output transistor pairs (21-22, 23-24, and 25-26) corresponding to individual phases of motor 2. Each output transistor pair may include a p-type insulated gate field effect transistor (IGFET) (21, 22, and 23) and an n-type IGFET (22, 24, and 26). Each transistor (21 to 26) may function as a switching device. Each transistor (21 to 26) may be a MOS (metal-oxide-semiconductor) type IGFET, as just one example.

Transistor 21 may have a source connected to a power supply voltage VDD, a drain connected to an output terminal P1, and a gate connected to receive a drive control signal 81. Transistor 22 may have a source connected to ground, a drain connected to output terminal P1, and a gate connected to receive a drive control signal 82. Transistor 23 may have a source connected to a power supply voltage VDD, a drain connected to an output terminal P2, and a gate connected to receive a drive control signal 83 from control circuit. Transistor 24 may have a source connected to ground, a drain connected to output terminal P2, and a gate connected to receive a drive control signal 84. Transistor 25 may have a source connected to a power supply voltage VDD, a drain connected to an output terminal P3, and a gate connected to receive a drive control signal 85. Transistor 26 may have a source connected to ground, a drain connected to output terminal P3, and a gate connected to receive a control signal 86.

Inverter circuit 11 may include diodes (31 to 36). A respective diode (31 to 36) may be connected in parallel to a respective transistor (21 to 26). Diode 31 may have an anode connected to output terminal P1 and a cathode connected to power supply voltage VDD. Diode 32 may have an anode connected to ground and a cathode connected to output terminal P1. Diode 33 may have an anode connected to output terminal P2 and a cathode connected to power supply voltage VDD. Diode 34 may have an anode connected to ground and a cathode connected to output terminal P2. Diode 35 may have an anode connected to output terminal P3 and a cathode connected to power supply voltage VDD. Diode 36 may have an anode connected to ground and a cathode connected to output terminal P3.

Each diode (31 to 36) may be formed parasitically in the formation of the backgate (body) connection of the respective transistor (21 to 26). Such a diode is generally called a “body diode” (or a “built-in diode”).

Motor 2 may include armature coils (L1 to L3). Each armature coil (L1 to L3) may have a commonly connected terminal and another terminal connected to a respective output terminal (P1 to P3) of inverter circuit 11. Output terminal P1 may be connected to armature coil L1. Output terminal P2 may be connected to armature coil L2. Output terminal P3 may be connected to armature coil L3.

Back electromotive force suppressing circuit 13 may include comparators (41 to 46), AND gates (51, 53, and 55), and OR gates (52, 54, and 56).

Comparator 41 may have a non-inverting input connected to receive power supply voltage VDD and an inverting input connected to output terminal P1 and may provide an output as an input to AND gate 51. Comparator 42 may have a non-inverting input connected to receive ground and an inverting input connected to output terminal P1 and may provide an output as an input to OR gate 52. Comparator 43 may have a non-inverting input connected to receive power supply voltage VDD and an inverting input connected to output terminal P2 and may provide an output as an input to AND gate 53. Comparator 44 may have a non-inverting input connected to receive ground and an inverting input connected to output terminal P2 and may provide an output as an input to OR gate 54. Comparator 45 may have a non-inverting input connected to receive power supply voltage VDD and an inverting input connected to output terminal P3 and may provide an output as an input to AND gate 55. Comparator 46 may have a non-inverting input connected to receive ground and an inverting input connected to output terminal P3 and may provide an output as an input to OR gate 56.

AND gate 51 may receive control signal V_{C1} and an output of comparator 41 as inputs and may provide a drive control signal 81 to a gate of transistor 21. OR gate 52 may receive control signal V_{C2} and an output of comparator 42 as inputs and may provide a drive control signal 82 to a gate of transistor 22. AND gate 53 may receive control signal V_{C3} and an output of comparator 43 as inputs and may provide a drive control signal 83 to a gate of transistor 23. OR gate 54 may receive control signal V_{C4} and an output of comparator 44 as inputs and may provide a drive control signal 84 to a gate of transistor 24. AND gate 55 may receive control signal V_{C5} and an output of comparator 45 as inputs and may provide a drive control signal 85 to a gate of transistor 25. OR gate 56 may receive control signal V_{C6} and an output of comparator 46 as inputs and may provide a drive control signal 86 to a gate of transistor 26.

When a voltage (V₀₁ to V₀₃) of a respective output terminal (P1 to P3) is higher than power supply voltage VDD, a respective comparator (41, 43, to 45) may provide an output having a logic low level (low). Otherwise, the respective comparator (41, 43, to 45) may provide an output having a logic high level (high).

When a voltage (V₀₁ to V₀₃) of a respective output terminal (P1 to P3) is lower than a ground potential, a respective comparator (42, 44, to 46) may provide an output having a high level. Otherwise, the respective comparator (42, 44, to 46) may provide an output having a low level.

Control circuit 12 may provide control signals (V_{C1} to V_{C6}) as outputs. A respective AND gate (51, 53, and 55) may provide a respective drive control signal (81, 83, and 85) having a logical product of a respective control signal (V_{C1}, V_{C3}, and V_{C5}) and an output of a respective comparator (41, 43, and 45). A respective OR gate (52, 54, and 56) may provide a respective drive control signal (82, 84, and 86) having a logical sum of a respective control signal (V_{C2}, V_{C4}, and V_{C6}) and an output of a respective comparator (42, 44, and 46).

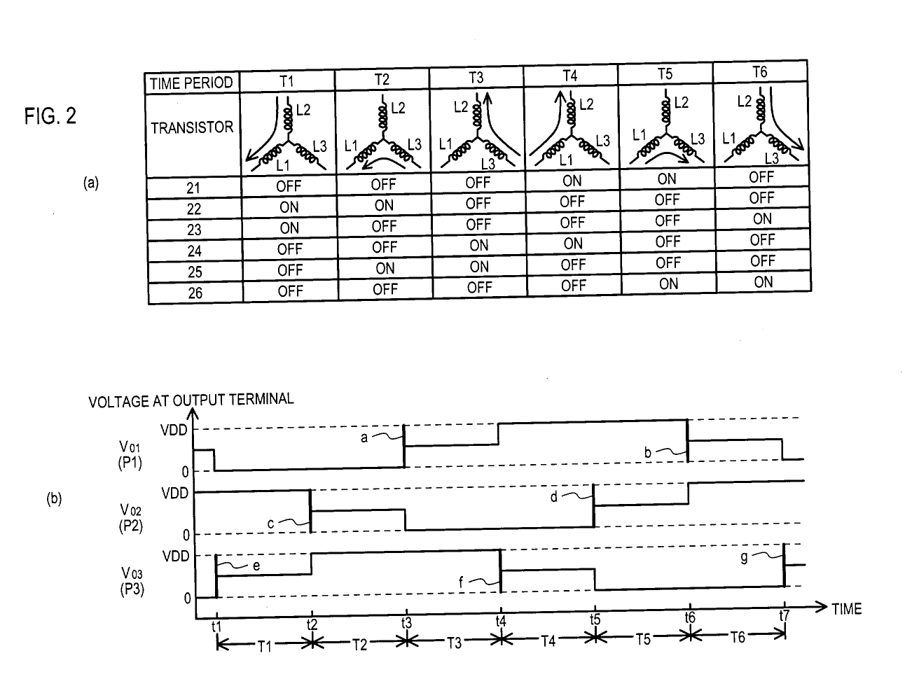

The operation of motor drive circuit 1 will now be described with reference to FIG. 2 in conjunction with FIG. 1.

FIG. 2(a) is a table illustrating the operating states (on/off) of transistors (21 to 26) and the direction of current flow in armature coils (L1 to L3) of three-phase brushless motor 2 in operation time periods (T1 to T6) according to an embodiment. FIG. 2(b) is a timing diagram illustrating voltage variations of output terminals (P1 to P3) in time periods (T1 to T6) according to an embodiment.

In motor drive circuit 1, operating states (on/off) of transistors (21, 23, and 25) may be essentially controlled in accordance with control signals (V_{C1}, V_{C3}, and V_{C5}). Specifically, as shown in FIG. 2(a), one of transistors (21, 23, and 25) may be turned on and the other two of transistors (21, 23, and 25) may be turned off in a time period (T1 to T6).

Operating states (on/off) of transistors (22, 24, and 26) may be essentially controlled in accordance with control signals (V_{C2}, V_{C4}, and V_{C6}). Specifically, as shown in FIG. 2(a), one of transistors (22, 24, and 26) may be turned on and the other two of transistors (22, 24, and 26) may be turned off in a time period (T1 to T6).

Control may be performed control circuit 12 so that a p-type IGFET (21, 23, and 25) and a corresponding n-type IGFET (22, 24, and 26) in an output transistor pair (21-22, 23-24, and 25-26) do not simultaneously (synchronously) turn on.

With operating states (on/off) of transistors (21 to 26) thus controlled, voltages (V₀₁ to V₀₃) of output terminals (P1 to P3) may have waveforms as illustrated in FIG. 2(b) provided to armature coils (L1 to L3) of motor 2, respectively. Accordingly, currents corresponding to voltages (V₀₁ to V₀₃) of output terminals (P1 to P3) may flow through armature coils (L1 to L3) as illustrated in FIG. 2(a). In this way, motor 2 may be rotationally driven.

In motor drive circuit 1, when transistors (22 to 26) turn from on to, off, back electromotive forces may be generated in armature coils (L1 to L3) of motor 2. For example, as shown in FIG. 2(a), in a time period T2, transistors (22 and 25) may each be turned on and transistors (21, 23, 24, and 26) may each be turned off. In this state, a current may flow from armature coil L3 of motor 1 to armature coil L1. In a subsequent time period T3, transistor 22 turns from on to off and transistor 24 turns from off to on. The instant transistor 22 turns off, the current in armature coil L1 may continue to flow due to inductive effects. As a result, a back electromotive force a may be generated at output terminal PI at time t3 and the voltage V₀₁ at output terminal P1 may be increased.

When voltage V₀₁ at output terminal P1 provided to comparator 41 becomes higher than power supply voltage VDD in accordance with a back electromotive force a (illustrated in FIG. 2(b) on output terminal P1 at time t3), comparator 41 may provide an output having a low level. Consequently, AND gate 51 may provide a drive control signal 81 having a low level. With drive control signal 81 low, transistor 21 may turn on (a current conduction state). Thus, energy associated with back electromotive force a may be discharged via transistor 21 to a power line carrying power supply voltage VDD. In this way, the voltage V₀₁ at output terminal P1 may decrease to the power supply voltage VDD.

When the voltage V₀₁ at output terminal P1 provided to comparator 41 decreases to the power supply voltage VDD or lower, comparator 41 may provide an output having a high level. At this time, AND gate 51 may provide a drive control signal 81 having a high level. With drive control signal 81 at a high level, transistor 21 may turn off (a high impedance state). Because transistor 21 only turns on at this time when a voltage V₀₁ at output terminal P1 becomes higher than power supply voltage VDD, the driving and operation of motor 2 may not be influenced.

On the other hand, as shown in FIG. 2(a), in a time period T5, transistors (21 and 26) may each be turned on and transistors (22, 23, 24, and 25) may each be turned off. In this state, a current may flow from armature coil L1 of motor 1 to armature coil L3. In a subsequent time period T6, transistor 21 turns from on to off and transistor 23 turns from off to on. The instant transistor 21 turns off, the current in armature coil L1 may continue to flow due to inductive effects. As a result, a back electromotive force b may be generated at output terminal P1 at time t6 and the voltage V₀₁ at output terminal P1 may be reduced.

When voltage V₀₁ at output terminal P1 provide to comparator 41 becomes lower than ground in accordance with a back electromotive force b (illustrated in FIG. 2(b) on output terminal P1 at time t6), comparator 42 may provide an output having a high level. Consequently, OR gate 52 may provide a drive control signal 82 having a high level. With drive control signal 82 high, transistor 22 may turn on (a current conduction state). Thus, energy associated with back electromotive force b may be discharged via transistor 22 to a power line carrying ground. In this way, the voltage V₀₁ at output terminal P1 may increase to the ground potential.

When the voltage V₀₁ at output terminal P1 provided to comparator 42 increases to the ground potential or higher, comparator 42 may provide an output having a low level. At this time, OR gate 52 may provide a drive control signal 82 having a low level. With drive control signal 82 at a low level, transistor 22 may turn off (a high impedance state). Because transistor 22 only turns on at this time when a voltage V₀₁ at output terminal P1 becomes lower than the ground potential, the driving and operation of motor 2 may not be influenced.

Also, when a back electromotive force is generated at output terminal (P2 or P3), the back electromotive force may be discharged to the power line or ground line according to the same operations (through transistors (23 to 26)) as described above.

More specifically, as shown in FIG. 2(b), a back electromotive force d may be generated at output terminal P2 at time t5, and back electromotive forces (e and g) may be generated at output terminal P3 at times (t1 and t7), respectively. In this case, energy associated with back electromotive force d may be discharged via transistor 23 to a power line. Also, energy associated with back electromotive forces (e and g) may be discharged via transistor 25 to a power line.

Also, as shown in FIG. 2(b), a back electromotive force c may be generated at output terminal P2 at time t2, and back electromotive force f may be generated at output terminal P3 at time t4. In this case, energy associated with back electromotive force c may be discharged via transistor 24 to a ground line. Also, energy associated with back electromotive force f may be discharged via transistor 26 to a ground line.

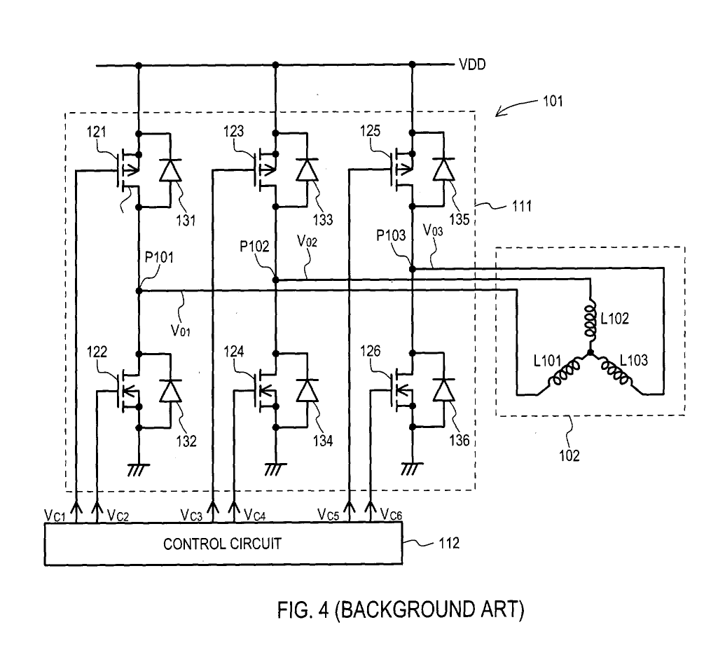

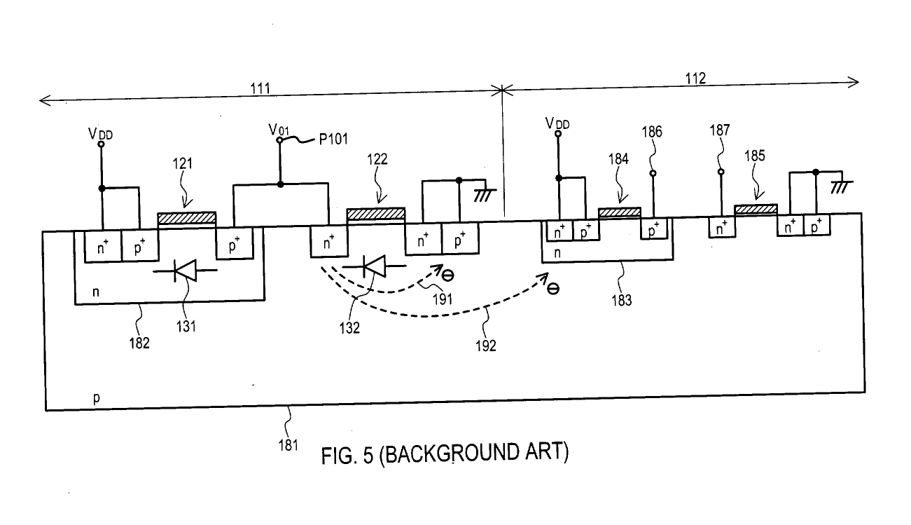

The back electromotive forces generated at output terminals (P1, P2, and P3) may be suppressed according to the above-described operations. Therefore, generation of back electromotive forces may not cause any of diodes (31 to 36) to turn on. Consequently, noise generation attributed to back electromotive forces as experienced with conventional motor drive circuit 101 shown in FIG. 4 may be reduced or prevented.

A case may occur in which timing of detecting back electromotive forces is not optimal because of manufacturing variations and insufficiency in response speeds of comparators (41 to 46).

For example, because of manufacturing variations, a case may occur in which an offset occurs between a non-inverting and an inverting input of comparator 41. Thus, transistor 21 may be turned on even when the voltage at output terminal P1 is lower than or equal to power supply voltage VDD. In this case, transistor 21 may turn on before a back electromotive force occurs and the timing may not be suitable for discharging a back electromotive force energy via transistor 21.

In addition, because of a lag in a response time of comparator 41, a case may occur in which transistor 21 turns on when the voltage at output terminal P1 exceeds (VDD+V_{F}), where V_{F} represents a voltage at which the body diode 31 turns on. In this case, transistor 21 may turn on during or after discharge of a back electromotive force energy via diode 31. Therefore, the timing may not be suitable for discharging the back electromotive force energy via transistor 21.

However, the timing for detecting the back electromotive force may be optimized by adjusting offset voltages of individual comparators (41 to 46). In this way, the above-described drawbacks may be avoided.

Specifically, each of the offset voltages of comparators (41, 43, and 45) may be adjusted so that each transistor (21, 23, and 25) may turn on when each of voltages (V₀₁, V₀₂, and V₀₃) at output terminals (P1, P2, and P3) exceeds power supply voltage VDD and is lower than (VDD+V_{F}) (that is when VDD<V₀₁<VDD+V_{F}, VDD<V₀₂<VDD+V_{F}, and VDD<V₀₃<VDD+V_{F}). Also, each of the offset voltages of comparators (42, 44, and 46) may be adjusted so that each transistor (22, 24, and 26) may turn on when each of voltages (V₀₁, V₀₂, and V₀₃) at output terminals (P1, P2, and P3) is lower than the ground potential and exceeds (−V_{F}) (that is when 0>V₀₁>−V_{F}, 0>V₀₂>−V_{F}, and 0>V₀₃>−V_{F}, where ground=0). As long as the back electromotive force is within the ranges described above, the back electromotive force may not substantially influence another circuit such as control circuit 12, for example.

Thus, the back electromotive force energy may be reliably discharged at optimal timing via transistors (21 to 26) by adjusting offset voltages of individual comparators (41 to 46). Consequently, the charge flow (for example, electron flow) generated in inverter circuit 11 due to back electromotive forces into control circuit 12 may be suppressed. Specifically, because charge may be controlled to flow through channels located closer to the surface of the semiconductor substrate than in the case of flowing through body diodes (31 to 36), the amount of charge injected into the substrate and interfering with control circuit 12, or the like, may be significantly reduced.

As described above, motor drive circuit 1 according to an embodiment may include comparators (41 to 46). Comparators (41 to 46) may detect back electromotive forces generated at output terminals (P1 to P3). Upon detection of a back electromotive force having a voltage higher than power supply voltage VDD, either one of comparator (41, 43, and 45) may cause a corresponding transistor (21, 23, and 25) to turn on (become conductive). Upon detection of a back electromotive force having a voltage lower than ground potential, either one of comparator (42, 44, and 46) may cause a corresponding transistor (22, 24, and 26) to turn on (become conductive).

In this way, when a back electromotive force higher than power supply voltage VDD is generated at one of output terminals (P1 to P3), the voltage (V₀₁ to V₀₃) at the respective output terminal (P1, P2, and P3) may be essentially held at the power supply voltage VDD. In contrast, when a back electromotive force lower than a ground potential is generated at one of output terminals (P1 to P3), the voltage (V₀₁ to V₀₃) at the respective output terminal (P1, P2, and P3) may be essentially held at the ground potential. Consequently, the back electromotive forces may be suppressed.

In addition, the timing of detection of back electromotive forces may be adjusted using offset voltages between individual non-inverting inputs and inverting inputs of comparators (41 to 46).

Because of the above, back electromotive forces may be suppressed before diodes (31 to 36) connected in parallel to respective transistors (21 to 26) become conductive. By preventing diodes (31 to 36) from becoming conductive due to back electromotive forces, noise generation attributed to back electromotive forces may be suppressed. In this way, the influence of back electromotive forces may be reduced.

Consequently, motor drive circuit 1 including control circuit 12 and other circuits that may be easily affected by back electromotive forces may be realized.

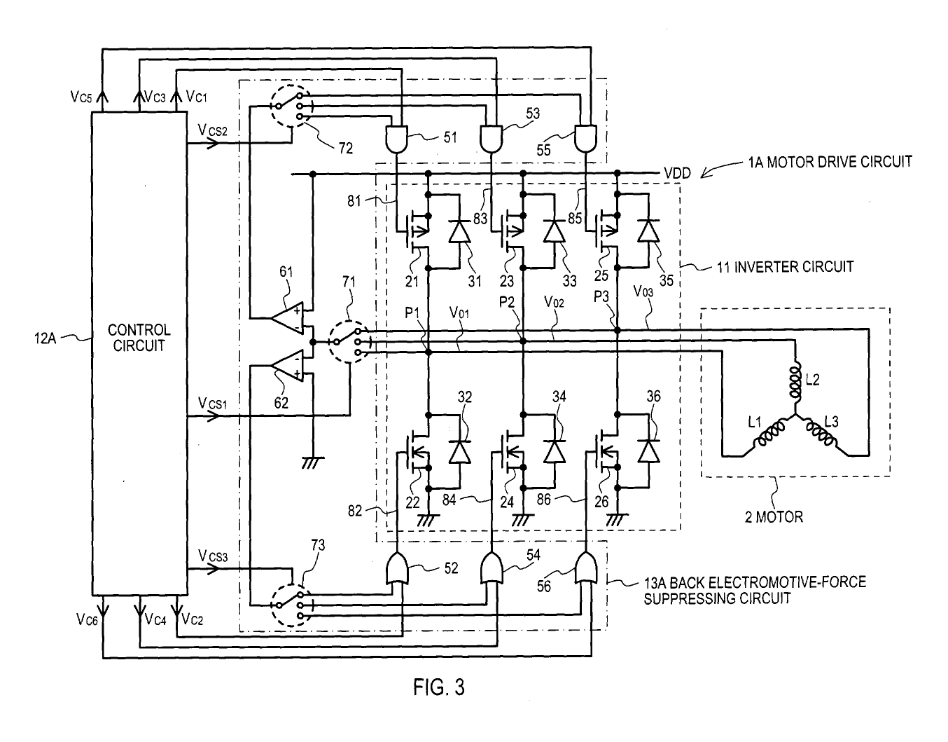

Referring now to FIG. 3, a circuit schematic diagram of a motor drive circuit according to an embodiment is set forth and given the general reference character 1A.

Motor drive circuit 1A of FIG. 3 may include similar constituents as motor drive circuit 1 of FIG. 1. Such constituents may be referred to by the same reference character and descriptions thereof may be omitted.

Motor drive circuit 1A may include an inverter circuit 11, a control circuit 12A, and a back electromotive force suppressing circuit 13A.

Back electromotive force suppressing circuit 13A may differ from back electromotive force suppressing circuit 13 of FIG. 1. In back electromotive force suppressing circuit 13A, comparators (61 and 62) may be included common to the three phases. Switch 71 may be included to provide inverting inputs to comparators (61 and 62). Switch 72 may be included to provide an output of comparator 61 to an input of one of AND gates (51, 53, and 55). Switch 73 may be included to provide an output of comparator 62 to an input of one of OR gates (52, 54, and 56).

Back electromotive force suppressing circuit 13A may include comparators (61 and 62), switches (71 to 73), AND gates (51, 53, and 55), and OR gates (52, 54, and 56).

Comparator 61 may have a non-inverting input connected to receive power supply voltage VDD and an inverting input connected to an output terminal of switch 71 and may provide an output as an input to switch 72. Comparator 62 may have a non-inverting input connected to receive ground and an inverting input connected to an output terminal of switch 71 and may provide an output as an input to switch 73.

Switch 71 may receive voltages (V₀₁, V₀₂, and V₀₃) from output terminals (P1, P2, and P3) as inputs. Switch 71 may provide one of voltages (V₀₁, V₀₂, and V₀₃) from output terminals (P1, P2, and P3) to the inverting inputs of comparators (61 and 62) in response to a switching control signal V_{CS1} provided from control circuit 12A. In this way, switch 71 may provide a 3 to 1 multiplexing function such that one of three voltages (V₀₁, V₀₂, and V₀₃) from output terminals (P1, P2, and P3) are provided as an output of switch 71.

Switch 72 may receive the output of comparator 61 and may have three output terminals, each output terminal may be connected to an input of a respective AND gate (51, 53, and 55). Switch 72 may provide the output of comparator 61 as an input of a respective AND gate (51, 53, and 55) in response to a switching control signal V_{CS2} provided from control circuit 12A. In this way, switch 72 may provide a 1 to 3 multiplexing function such that the output of comparator 61 may be provided to one of three output terminals of switch 72.

Switch 73 may receive the output of comparator 62 and may have three output terminals, each output terminal may be connected to an input of a respective OR gate (52, 54, and 56). Switch 73 may provide the output of comparator 62 as an input of a respective AND gate (52, 54, and 56) in response to a switching control signal V_{CS3} provided from control circuit 12A. In this way, switch 73 may provide a 1 to 3 multiplexing function such that the output of comparator 62 may be provided to one of three output terminals of switch 73.

AND gate 51 may receive control signal V_{C1} and a first output of switch 72 as inputs and may provide a drive control signal 81 to a gate of transistor 21. OR gate 52 may receive control signal V_{C2} and a first output of switch 73 as inputs and may provide a drive control signal 82 to a gate of transistor 22. AND gate 53 may receive control signal V_{C3} and a second output of switch 72 as inputs and may provide a drive control signal 83 to a gate of transistor 23. OR gate 54 may receive control signal V_{C4} and a second output of switch 73 as inputs and may provide a drive control signal 84 to a gate of transistor 24. AND gate 55 may receive control signal V_{C5} and a third output of switch 72 as inputs and may provide a drive control signal 85 to a gate of transistor 25. OR gate 56 may receive control signal V_{C6} and a third output of switch 73 as inputs and may provide a drive control signal 86 to a gate of transistor 26.

Control circuit 12A may provide control signals (V_{C1} to V_{C6}) and switching control signals(V_{CS1} to V_{CS3}) as outputs. A respective AND gate (51, 53, and 55) may provide a respective drive control signal (81, 83, and 85) having a logical product of a respective control signal (V_{C1}, V_{C3}, and V_{C5}) and a respective output of switch 72. A respective OR gate (52, 54, and 56) may provide a respective drive control signal (82, 84, and 86) having a logical sum of a respective control signal (V_{C2}, V_{C4}, and V_{C6}) and a respective output of switch 73.

In motor drive circuit 1A, switches (71, 72, and 73) may be driven to perform switching in coincidence with timings of a generation of back electromotive forces (a, b, c, d, e, and f) illustrated in FIG. 2. In this way, comparators (61 and 62) may detect all of back electromotive forces (a, b, c, d, e, and f) turn on a respective transistor (21 to 36) accordingly. The timings of the generation of the back electromotive forces (a, b, c, d, e, and f) may rely on the waveforms of voltages (V₀₁, V₀₂, and V₀₃) from output terminals (P1, P2, and P3) (i.e., PWM driving waveforms). In this way, it may be possible to drive switches (71, 72, and 73) to perform switching so that back electromotive forces (a, b, c, d, e, and f) may be sufficiently detected.

In motor drive circuit 1A of the embodiment of FIG. 3, the same effects as in motor drive circuit 1 of the embodiment of FIG. 1 may be obtained.

In addition, compared to motor drive circuit 1, motor drive circuit 1A may have fewer comparators. In this way, chip size and manufacturing costs may be reduced.

In a motor drive circuit according to the embodiments, forward biasing of parasitic devices due to back electromotive forces may be prevented. In this way, noise affects on circuits, such as a control circuit, may be reduced.

Inverter circuit 1 may be conceptualized as a drive circuit that drives armature coils (L1 to L3). A back electromotive force suppressing circuit (13 and 13A) may be conceptualized as a detection circuit and may detect a voltage level at output terminals (P1 to P3).

It is understood that the embodiments described above are exemplary and the present invention should not be limited to those embodiments. Specific structures should not be limited to the described embodiments.

For example, the number of phases is not specifically limited and the embodiments may be applied to motors other than a three-phase motor.

Although the embodiments have used transistors (21 to 26) that may be IGFETs, other transistors, such as bipolar transistors as just one example, may be used.

As described above, according to a motor drive circuit of the embodiments, noise generation attributable to back electromotive forces may be reduced. Additionally, adjustment may be implemented to minimize the influence of back electromotive forces.

In this way, a motor drive circuit according to the embodiments may be realized such that control circuits or the like may have a reduced influence from back electromotive forces.

Thus, while the various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A motor drive circuit, comprising:
an inverter circuit including
a plurality of individual first transistors, each first transistor having a current path coupled between a first power line for supplying a first voltage and one of a plurality of output terminals;
a plurality of individual second transistors, each second transistor having a current path coupled between one of the plurality of output terminals and a second power line for supplying a second voltage;
a control circuit providing a plurality of first control signals for controlling conduction/non-conduction of the plurality of first transistors and a plurality of second control signals for controlling conduction/non-conduction of the plurality of second transistors to provide power to armature coils of a motor via the plurality of output terminals;
a plurality of first comparators, each first comparator comparing a voltage at a corresponding one of the output terminals with the first voltage to detect the generation of a first back electromotive force; and
a plurality of second comparators, each second comparator comparing a voltage at a corresponding one of the output terminals with the second voltage to detect the generation of a second back electromotive force wherein
upon detection of the first back electromotive force, one of the plurality of first comparators provides a first comparator output that places the first transistor corresponding to the output terminal at which the first back electromotive force has been detected to a conduction state and upon detection of the second back electromotive force, one of the plurality of second comparators provides a second comparator output that places the second transistor corresponding to the output terminal at which the second back electromotive force has been detected to a conduction state.

2. The motor drive circuit according to claim 1, further including:
a plurality of AND gates, each AND gate provides the logical product of one of the plurality of first control signals and one of the first comparator outputs to provide a first drive control signal to a control gate of one of the plurality of first transistors.

3. The motor drive circuit according to claim 1, further including:
a plurality of OR gates, each OR gate provides the logical sum of one of the plurality of second control signals and one of the second comparator outputs to provide a second drive control signal to a control gate of one of the plurality of second transistors.

4. The motor drive circuit according to claim 1, wherein:
each of the plurality of first transistors and the plurality of second transistors is an insulated gate field effect transistor (IGFET).

5. The motor drive circuit according to claim 4, wherein:
each of the plurality of first transistors is a p-type IGFET; and
each of the plurality of second transistors is a n-type IGFET.

6. A motor drive circuit, comprising:
an inverter circuit including
a plurality of individual first transistors, each first transistor having a current path coupled between a first power line for supplying a first voltage and one of a plurality of output terminals;
a plurality of individual second transistors, each second transistor having a current path coupled between one of the plurality of output terminals and a second power line for supplying a second voltage;
a control circuit providing a plurality of first control signals for controlling conduction/non-conduction of the plurality of first transistors and a plurality of second control signals for controlling conduction/non-conduction of the plurality of second transistors to provide power to armature coils of a motor via the plurality of individual output terminals;
a first comparator that compares a voltage at one of the plurality of output terminals with the first voltage to detect the generation of a first back electromotive force; and
a second comparator that compares a voltage at one of the plurality of output terminals with the second voltage to detect the generation of a second back electromotive force wherein
upon detection of the first back electromotive force, the first comparator provides a first comparator output that places the first transistor corresponding to the one of the plurality of output terminals at which the first back electromotive force has been detected to a conduction state and upon detection of the second back electromotive force, the second comparator provides a second comparator output that places the second transistor corresponding to the one of the plurality of output terminals at which the second back electromotive force has been detected to a conduction state.

7. The motor drive circuit according to claim 6, further including:
a first switch that provides the voltage of one of the plurality of output terminals to the first and second comparators;
a second switch that provides the first comparator output to the first transistor corresponding to the one of the plurality of output terminals having the voltage provided by the first switch; and
a third switch that provides the second comparator output to the second transistor corresponding to the one of the plurality of output terminals having the voltage provided by the first switch.

8. The motor drive circuit according to claim 7, further including:
a plurality of AND gates, each AND gate provides the logical product of one of the plurality of first control signals and the first comparator output to provide a first drive control signal to a control gate of one of the plurality of first transistors.

9. The motor drive circuit according to claim 7, wherein:
a plurality of OR gates, each OR gate provides the logical sum of one of the plurality of second control signals and the second comparator output to provide a second drive control signal to a control gate of one of the plurality of second transistors.

10. The motor drive circuit according to claim 6, wherein:
each of the plurality of first transistors and the plurality of second transistors is an insulated gate field effect transistor (IGFET).

11. The motor drive circuit according to claim 10, wherein:
each of the plurality of first transistors is a p-type IGFET; and
each of the plurality of second transistors is a n-type IGFET.

12. A motor drive circuit, comprising:
a drive circuit coupled to a plurality of output terminals, the drive circuit including
a first transistor for each output terminal providing a first controllable impedance path between the output terminal and a first power terminal;
a second transistor for each output terminal providing a second controllable impedance path between the output terminal and a second power terminal; and
a detection circuit coupled to receive a voltage from one of the plurality of output terminals and providing a first detection signal that turns on the first transistor corresponding to the one of the plurality of output terminals from which the voltage is received when the received voltage reaches a first predetermined voltage.

13. The motor drive circuit according to claim 12, wherein:
the first power terminal receives a first voltage level;
the second power terminal receives a second voltage level lower than the first voltage level; and
the first predetermined voltage is a voltage higher than the first voltage level.

14. The motor drive circuit according to claim 13, wherein:
each of the first transistors are p-type insulated gate field effect transistors (IGFETs).

15. The motor drive circuit according to claim 12, wherein:
the first power terminal receives a first voltage level;
the second power terminal receives a second voltage level higher than the first voltage level; and
the first predetermined voltage is a voltage lower than the first voltage level.

16. The motor drive circuit according to claim 15, wherein:
each of the first transistors are n-type insulated gate field effect transistors (IGFETs).

17. The motor drive circuit according to claim 12, wherein:
the detection circuit includes
a comparator having a non-inverting input coupled to the first power terminal and an inverting input coupled to the one of the plurality of output terminals and an output coupled to provide the first detection signal.

18. The motor drive circuit according to claim 12, wherein:
the detection circuit providing a second detection signal that turns on the second transistor corresponding to the one of the plurality of output terminals from which the voltage is received when the received voltage reaches a second predetermined voltage.

19. The motor drive circuit according to claim 12, wherein:
the detection circuit is coupled to receive a voltage from each of the plurality of output terminals and providing a first detection signal for each first transistor;
each first transistor turns on in response to the corresponding first detection signal when the corresponding output terminal reaches the first predetermined voltage.

20. The motor drive circuit according to claim 12, wherein:
the drive circuit providing power to armature coils of a motor via the plurality of output terminals.
